(19) United States
(12) Patent Application Publication
(10) Pub. No.: US 2007/0092817 A1
(43) Pub. Date: Apr. 26, 2007

(54) Imaging member

(75) Inventors: Greg McGuire, Mississauga (CA); John Graham, Oakville (CA); Zoran D. Popovic, Mississauga (CA); Ah-Mee Hor, Mississauga (CA); Stephan V. Drappel, Toronto (CA); Johann Junginger, Toronto (CA)

Correspondence Address: Richard M. Klein, Esq.;FAY, SHARPE, FAGAN, MINNICH & McKEE, LLP, SEVENTH FLOOR, 100 SUPERIOR AVENUE, CLEVELAND, OH, 44114-2579, US

(73) Assignee: XEROX CORPORATION

(21) Appl. No.: 11/257,668

(22) Filed: Oct. 25, 2005

(51) Int. Cl. G03G 5/147

(52) U.S. Cl. 430/66; 430/132

(57) ABSTRACT

An imaging member having an overcoat layer formed from a high viscosity overcoat composition. The viscosity of the overcoat composition is sufficient for reducing or preventing the diffusion of charge transport molecules into the overcoat layer. For example, in one embodiment the magnitude of diffusion of charge transport molecules is controlled by the viscosity of the overcoat composition used to form the overcoat layer. Other embodiments are also disclosed.

### BACKGROUND

The present disclosure relates, in various embodiments, to imaging members comprising an overcoat layer and methods of forming such imaging members. The overcoat layer in accordance with the present disclosure is formed from a flowable, high viscosity composition. The viscosity of the overcoat composition is sufficient to reduce or control the diffusion of charge transport material into the overcoat layer. Consequently, at least the outer surface of the overcoat layer is substantially free of charge transport material.

In the art of electrophotography, an electrophotographic imaging member or plate comprising a photoconductive insulating layer on a conductive layer is imaged by first uniformly electrostatically charging the surface of the photoconductive insulating layer. The plate is then exposed to a pattern of activating electromagnetic radiation, for example light, which selectively dissipates the charge in the illuminated areas of the photoconductive insulating layer while leaving behind an electrostatic latent image in the non-illuminated areas. This electrostatic latent image may then be developed to form a visible image by depositing finely divided electroscopic toner particles, for example from a developer composition, on the surface of the photoconductive insulating layer. The resulting visible toner image can be transferred to a suitable receiving member such as paper. This imaging process may be repeated many times with reusable photosensitive members.

Electrophotographic imaging members are usually multilayered photoreceptors that comprise a substrate support, an electrically conductive layer, an optional hole blocking layer, an optional adhesive layer, a charge generating layer, a charge transport layer, and an optional protective or overcoat layer(s). The imaging members can take several forms, including flexible belts, rigid drums, etc. For most multilayered flexible photoreceptor belts, an anti-curl layer is usually employed on the back side of the substrate support, opposite to the side carrying the electrically active layers, to achieve the desired photoreceptor flatness.

One type of multi-layered photoreceptor that has been employed as a belt in electrophotographic imaging systems comprises a substrate, a conductive layer, a charge blocking layer, a charge generating (photogenerating) layer, and a charge transport layer. The charge transport layer often comprises an activating small molecule dispersed or dissolved in a polymeric film forming binder. Generally, the polymeric film forming binder in the transport layer is electrically inactive by itself and becomes electrically active when it contains the activating molecule. The expression “electrically active” means that the material is capable of supporting the injection of photogenerated charge carriers from the material in the charge generating layer and is capable of allowing the transport of these charge carriers through the electrically active layer in order to discharge a surface charge on the active layer. The multi-layered type of photoreceptor may also comprise additional layers such as an anti-curl backing layer, required when layers possess different coefficient of thermal expansion values, an adhesive layer, and an overcoat layer. Commercial high quality photoreceptors have been produced which utilize an anti-curl coating.

Imaging members are generally exposed to repetitive electrophotographic cycling which subjects exposed layers of imaging devices to abrasion, chemical attack, heat and multiple exposures to light. This repetitive cycling leads to a gradual deterioration in the mechanical and electrical characteristics of the exposed layers. For example, repetitive cycling has adverse effects on exposed portions of the imaging member. Attempts have been made to overcome these problems. However, the solution of one problem often leads to additional problems.

In electrophotographic imaging devices, the charge transport layer may comprise a high loading of a charge transport compound dispersed in an appropriate binder. The charge transport compound may be present in an amount greater than about 35% based on weight of the binder. For example, the charge transport layer may comprise 50% of a charge transport compound in about 50% binder. A high loading of charge transport compound appears to drive the chemical potential of the charge transport layer to a point near the metastable state, which is a condition that induces crystallization, leaching and stress cracking when placed in contact with a chemically interactive solvent or ink. Photoreceptor functionality may be completely destroyed when a charge transport layer having a high loading of a charge transport molecule is contacted with liquid ink. It is thus desirable to eliminate charge transport molecule crystallization, leaching and solvent-stress charge transport layer cracking.

Cracks developed in the charge transport layer during cycling are a frequent phenomenon and most problematic because they can manifest themselves as print-out defects which adversely affect copy quality. Charge transport layer cracking has a serious impact on the versatility of a photoreceptor and reduces its practical value for automatic electrophotographic copiers, duplicators and printers.

Another problem encountered with electrophotographic imaging members is corona species induced deletion in print due to degradation of the charge transport molecules by chemical reaction with corona species. During electrophotographic charging, corona species are generated. Corona species include, for example ozone, nitrogen oxides, acids and the like.

Other problems affecting the performance of the imaging member include lateral charge migration and stress cracking in the photoreceptor. The concentration of charge transport molecules in the charge transport layer is a known factor affecting the degree of lateral charge migration. In particular, higher concentrations of charge transport molecules near the surface of the charge transport layer tend to result in a higher degree of lateral charge migration and more stress cracks.

Recent developments in reducing these defects have been directed to the formation of the charge transport layer. For example, the charge transport layer may be coated in two passes with a high loading of charge transport material in the first pass and a decreased loading of charge transport material in the second pass. The above two-pass coating should provide a charge transport layer with sufficient concentration of charge transport material for effective charge transport that has a reduced concentration of charge transport materials at the surface of the charge transport layer. The theoretical benefit of a lower concentration of charge transport material in the second pass is not completely achieved because the first layer tends to dissolve during coating of the second layer. This results in intermixing of the first pass and second pass layers and a greater concentration of charge transport material closer to the surface of the charge transport layer than is theoretically expected.

One approach to achieving longer photoreceptor drum life is to form a protective overcoat on the imaging surface, e.g. the charge transporting layer of a photoreceptor. This overcoat layer must satisfy many requirements, including transporting holes, resisting image deletion, resisting wear and avoidance of perturbation of underlying layers during coating. Although various hole transporting small molecules can be used in overcoat layers, one of the toughest known overcoats includes cross-linked polyamide (e.g. Luckamide) containing N,N′-diphenyl-N,N′-bis(3-hydroxyphenyl)-[1,1 ′-biphenyl]-4,4′-diamine. This overcoat is described in U.S. Pat. No. 5,368,967, the entire disclosure of which is incorporated herein by reference.

Durable photoreceptor overcoats containing cross-linked polyamide (e.g. Luckamide) and N,N′-diphenyl-N,N′-bis(3-hydroxyphenyl)-[1,1′-biphenyl]-4,4′-diamine (DHTBD) have been prepared using oxalic acid and trioxane to improve photoreceptor life by at least a factor of 3 to 4. The improved wear resistance involved cross-linking of Luckamide under heat treatment, e.g. 110° C.-120° C. for about 30 minutes. However, adhesion of this overcoat to certain photoreceptor charge transport layers, containing certain polycarbonates (e.g., Z-type 300) and charge transport materials [e.g., bis-N,N-(3,4-dimethylphenyl)-N-(4-biphenyl) amine and N,N′-diphenyl-N,N′-bis(3-methylphenyl)-[1,1′-biphenyl]-4,4′- diamine] is greatly reduced under such drying conditions. On the other hand, under drying conditions of below about 110° C., the overcoat adhesion to the charge transport layer was good, but the overcoat had a high rate of wear. Thus, there was an unacceptably small drying condition window for the overcoat to achieve the targets of both adhesion and wear rate.

One known long-life overcoat formulation depends upon acid catalyzed condensation of N-methoxy-methyl groups and N—H units. This overcoat formulation can be a self-condensation of Luckamide, which contains both units, or a cross-linking agent, such as hexamethoxymethylmelamine (commercial name Cymel 303) plus Luckamide or Elvamide (the latter two materials being alcohol soluble nylon polyamides). While these formulations have beneficial wear properties, they suffer from certain drawbacks, including limited pot life. In addition, the acid catalyst at optimum concentration can degrade the electrical properties of the photoreceptor layers. Moreover, there is no effective method to chemically bond surface energy reducing components into the overcoat composition to improve the performance of the overcoat with certain toners.

In spite of the many improvements, there remains a need for an effective, wear resistant overcoat. Since the drums are typically dip coated, one of the requirements for the overcoat material is ease and economical synthesis of materials and a coating solution pot life of several weeks. Pot life is the life of the coating composition without changes in its properties so that the same mixture can be used for several weeks. With coating compositions that ultimately cross-link and provide wear protection, there is a danger of initiation of cross-linking in the pot itself rendering the remaining material in the pot useless. Since the unused material must be discarded and the pot cleaned or replaced, this waste of material and effort has a significant negative impact on the manufacturing cost.

In U.S. Pat. No. 5,702,854 to Schank et al., issued Dec. 30, 1998, the disclosure of which is incorporated hereby in its entirety, an electrophotographic imaging member is disclosed including a supporting substrate coated with at least a charge generating layer, a charge transport layer and an overcoat layer, the overcoat layer comprising a dihydroxy arylamine dissolved or molecularly dispersed in a cross-linked polyamide matrix. The overcoat layer is formed by cross-linking a cross-linkable coating composition including a polyamide containing methoxy methyl groups attached to amide nitrogen atoms, a cross-linking catalyst and a dihydroxy amine, and heating the coating to cross-link the polyamide. The electrophotographic imaging member may be imaged in a process involving uniformly charging the imaging member, exposing the imaging member with activating radiation in image configuration to form an electrostatic latent image, developing the latent image with toner particles to form a toner image, and transferring the toner image to a receiving member.

U.S. Pat. No. 5,681,679, issued to Schank, et al. on Oct. 28, 1997, the entire disclosure of which is incorporated herein by reference, discloses a flexible electrophotographic imaging member including a supporting substrate and a resilient combination of at least one photoconductive layer and an overcoat layer, the at least one photoconductive layer comprising a hole transporting arylamine siloxane polymer and the overcoat comprising a cross-linked polyamide doped with a dihydroxy amine. This imaging member may be utilized in an imaging process including forming an electrostatic latent image on the imaging member, depositing toner particles on the imaging member in conformance with the latent image to form a toner image, and transferring the toner image to a receiving member.

U.S. Pat. No. 4,515,882, also incorporated herein by reference in its entirety, discloses an electrophotographic imaging system utilizing a member comprising at least one photoconductive layer and an overcoat layer. The overcoat layer comprises a film forming continuous phase comprising charge transport molecules and finely divided charge injection enabling particles.

U.S. Pat. No. 5,055,366 discloses an overcoat layer containing a film forming binder material or polymer blend doped with a charge transport compound. The charge transport compound is present in an amount of less than about 10% by weight. Alternatively, the overcoat layer may contain a single component hole transporting carbazole polymer or polymer blend of a hole transport carbazole polymer with a film forming binder. The disclosure of this patent is fully incorporated herein by reference.

U.S. Pat. No. 4,784,928 to Kan et al., the disclosure of which is incorporated in its entirety herein by reference, discloses a reusable electrophotographic element comprising first and second charge transport layers. The second charge transport layer has irregularly shaped fluorotelomer particles an electrically nonconductive substance dispersed in a binder resin. The second charge transport layer allows for toner to be uniformly transferred to a contiguous receiver element with minimal image defects.

U.S. Pat. No. 4,260,671 to Merrill discloses various polycarbonate overcoats which provide an increased resistance to solvents and abrasions. U.S. Pat. No. 4,390,609 to Wiedemann discloses a protective transparent cover layer made of an abrasion-resistant binder composed of polyurethane resin and a hydroxyl group containing polyester or polyether, and a polyisocyanate. The disclosures of these two patents are also fully incorporated herein by reference.

Often a deletion control agent is included in the overcoat layer. Deletions can occur due to the oxidation effects of the corotron or bias charging roll affluence that increases the conductively of the photoreceptered surface. Deletion control agents minimize this conductivity change. Some examples of deletion control agents include triphenyl methanes with nitrogen containing substituents such as bis-(2-methol-4-diethylaminophenyl)-phenyl methane and the like, hindered phenyls such as butylated hydroxy toluene and the like. Alcohol soluable deletion control agents can be added directly into the coating solution. Alcohol insoluable deletion control agents can first be dissolved in non-alcohol solvents such as tetrahydrofuran, monochlorobenzyne or the like and mixtures thereof and then added to the overcoat solution.

There is still a need to provide an overcoat layer that will reduce lateral charge migration, deletion, and/or stress cracking in an imaging member while still providing an imaging member that exhibits satisfactory electrical properties.

### BRIEF DESCRIPTION

Disclosed herein, in various embodiments, is a photoconductive imaging member having an overcoat layer and methods of producing such an imaging member. The overcoat layer is formed from a flowable, high viscosity overcoat composition. The viscosity of the overcoat composition is sufficient to reduce or minimize the diffusion of charge transport material into the overcoat layer. As a result, at least the outer surface of the overcoat layer is substantially free of charge transport material. Also included is the imaging member and overcoat layer produced by the methods and processes of utilizing the same for imaging.

The present disclosure, in further embodiments thereof, also includes an imaging member comprising a substrate; a charge generating layer; a charge transport layer comprising a charge transport material; and an overcoat layer disposed over the charge transport layer, wherein the overcoat layer comprises essentially of a film forming polymer material. The overcoat layer is formed from a flowable, high viscosity overcoat composition comprising a film forming polymer material and a solvent. This composition is of a sufficient viscosity to inhibit or minimize diffusion of the charge transport material from the charge transport layer. This results in an overcoat layer which has at least an outer surface which is substantially free of a charge transport material. A method of imaging employing this imaging member is also included in the present disclosure.

Furthermore, the present disclosure is directed to, in additional embodiments thereof, a method for forming an imaging member comprising providing a layer comprising a charge transport material; and depositing a flowable, high viscosity overcoat composition over the layer comprising the charge transport material. The imaging member formed by this method is also included in the present disclosure. In one embodiment, the overcoat composition has a solids content that is less than the percent solids at which the overcoat composition exhibits a viscosity of 50,000 cps or more measured at a sheer rate of 1.0 s⁻¹ at 25° C.

These and other non-limiting features or characteristics of the disclosure are more particularly disclosed below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a schematic cross sectional view of a photoconductive imaging member in accordance with the present disclosure;

FIGS. 2 and 3 show PIDC graphs comparing the electrical properties of devices comprising different polymer overcoat layers with a device having no overcoat layer;

FIG. 4 illustrates graphs of electrical characteristics of various overcoat layers as compared to a control with no overcoat.

FIGS. 5 and 6 show photographs comparing the deletion resistance of photoconductive imaging devices employing different polymer overcoat layers to devices with no overcoat layer; and

FIGS. 7 and 8 are print-outs comparing the stress cracking of devices employing a polymer overcoat layer in accordance with the present disclosure to control devices with no overcoat layer.

### DETAILED DESCRIPTION

The present disclosure relates to a photoconductive imaging member having an overcoat layer. An imaging member comprises a layer comprising a charge transport material and an overcoat composition disposed over the layer that comprises the charge transport material. For example, an imaging member may comprise, in one embodiment, a substrate, a charge generation layer, a charge transport layer, and an overcoat layer disposed over the charge transport layer. The overcoat layer is formed from a film forming polymer composition having a high viscosity. This composition is of sufficient viscosity to inhibit or minimize diffusion of charge transport material from the charge transport layer into the overcoat layer. This results in an overcoat layer having at least an outer surface substantially free of a charge transport material. Consequently, the overcoat layer limits the diffusion of charge transport molecules and reduces the concentration of such molecules near the surface of the device that would lead to cracking or deterioration of the devices electrical performance. The present disclosure also relates to a process for forming the photoconductive imaging member and the overcoat layer.

Also included within the scope of the present disclosure are methods of imaging and printing with the photoresponsive devices illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697; and, 4,338,390, the disclosures of which are totally incorporated herein by reference, subsequently transferring the image to a suitable substrate, and permanently affixing the image thereto.

A more complete understanding of the processes and apparatuses disclosed herein can be obtained by reference to the accompanying drawings. These figures are merely schematic representations based on convenience and the ease of demonstrating the present development, and are, therefore, not intended to indicate relative size and dimensions of the imaging devices or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to component of like function.

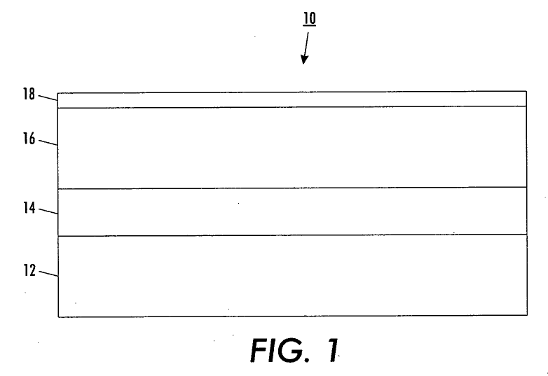

With reference to FIG. 1, a photoconductive imaging member in accordance with the present disclosure is shown. Photoconductive imaging member 10 comprises a substrate 12, a charge generating or photogenerating layer 14, a charge transport layer 16, and an overcoat layer 18. Overcoat layer 18 is formed from a flowable, high-viscosity polymer composition in accordance with the present disclosure.

The substrate may be opaque or substantially transparent and may comprise any suitable material having the required mechanical properties. Accordingly, the substrate may comprise a layer of an electrically non-conductive or conductive material such as an inorganic or an organic composition. Various resins may be employed as non-conductive materials including polyesters, polycarbonates, polyamides, polyurethanes, and the like, which are flexible as thin webs. An electrically conducting substrate may be any metal, for example, aluminum, nickel, steel, copper, and the like or a polymeric material, as described above, filled with an electrically conducting substance, such as carbon, metallic powder, and the like or an organic electrically conducting material. The electrically insulating or conductive substrate may be in the form of an endless flexible belt, a web, a rigid cylinder, a sheet and the like.

The thickness of the substrate layer depends on numerous factors, including strength and desired and economical considerations. Thus, for a drum, this layer may be of substantial thickness of, for example, up to many centimeters or of a minimum thickness of less than a millimeter. Similarly, a flexible belt may be of substantial thickness, for example, about 250 micrometers, or of minimum thickness, e.g., less than 50 micrometers, provided there are no adverse effects on the final electrophotographic device.

In embodiments where the substrate layer is not conductive, the surface thereof may be rendered electrically conductive by an electrically conductive coating. The conductive coating may vary in thickness over substantially wide ranges depending upon the optical transparency, degree of flexibility desired, and economic factors. Accordingly, for a flexible photoresponsive imaging device, the thickness of the conductive coating may be from about 20 angstroms to about 750 angstroms, and more preferably from about 100 angstroms to about 200 angstroms for an optimum combination of electrical conductivity, flexibility, and light transmission. The flexible conductive coating may be an electrically conductive metal layer formed, for example, on the substrate by any suitable coating technique, such as a vacuum depositing technique or electrodeposition. Typical metals include aluminum, zirconium, niobium, tantalum, vanadium and hafnium, titanium, nickel, stainless steel, chromium, tungsten, molybdenum, and the like.

An optional hole blocking layer may be applied to the substrate. Any suitable and conventional blocking layer capable of forming an electronic barrier to holes between the adjacent photoconductive layer and the underlying conductive surface of a substrate may be utilized.

An optional adhesive layer may be applied to the hole blocking layer. Any suitable adhesive layer may be utilized and such adhesive layer materials are well known in the art. Typical adhesive layer materials include, for example, polyesters, polyurethanes, and the like. Satisfactory results may be achieved with adhesive layer thickness from about 0.05 micrometer (500 angstroms) and about 0.3 micrometer (3,000 angstroms). Conventional techniques for applying an adhesive layer coating mixture to the charge blocking layer include spraying, dip coating, roll coating, wire wound rod coating, gravure coating, Bird applicator coating, and the like. Drying of the deposited coating may be effected by any suitable conventional technique such as oven drying, infra red radiation drying, air drying, and the like.

At least one electrophotographic imaging layer is formed on the adhesive layer, blocking layer, or substrate. The electrophotographic imaging layer may be a single layer that performs both charge generating and charge transport functions, as is well known in the art, or it may comprise multiple layers such as a charge generator layer and charge transport layer. Charge generator (also referred to as photogenerating) layers may comprise amorphous films of selenium and alloys of selenium and arsenic, tellurium, germanium and the like, hydrogenated amorphous silicon and compounds of silicon and germanium, carbon, oxygen, nitrogen, and the like fabricated by vacuum evaporation or deposition. The charge generator layers may also comprise inorganic pigments of crystalline selenium and its alloys; Group Il-VI compounds; and organic pigments such as quinacridones, polycyclic pigments such as dibromo anthanthrone pigments, perylene and perinone diamines, polynuclear aromatic quinones, azo pigments including bis-, tris- and tetrakisazos; and the like dispersed in a film forming polymeric binder and fabricated by solvent coating techniques. Illustrative organic photoconductive charge generating materials include azo pigments such as Sudan Red, Dian Blue, Janus Green B, and the like; quinone pigments such as Algol Yellow, Pyrene Quinone, Indanthrene Brilliant Violet RRP, and the like; quinocyanine pigments; perylene bisimide pigments; indigo pigments such as indigo, thioindigo, and the like; bisbenzoimidazole pigments such as Indofast Orange toner, and the like; phthalocyanine pigments such as titanyl phthalocyanine, aluminochlorophthalocyanine, hydroxygalliumphthalocyanine, and the like; quinacridone pigments; or azulene compounds. Suitable inorganic photoconductive charge generating materials include for example cadium sulfide, cadmium sulfoselenide, cadmium selenide, crystalline and amorphous selenium, lead oxide and other chalcogenides. Alloys of selenium are encompassed by embodiments of the disclosure and include for instance selenium-arsenic, selenium-tellurium-arsenic, and selenium-tellurium.

Phthalocyanines have been employed as photogenerating materials for use in laser printers utilizing infrared exposure systems. Infrared sensitivity is required for photoreceptors exposed to low cost semiconductor laser diode light exposure devices. The absorption spectrum and photosensitivity of the phthalocyanines depend on the central metal atom of the compound. Many metal phthalocyanines have been reported and include, oxyvanadium phthalocyanine, chloroaluminum phthalocyanine, copper phthalocyanine, oxytitanium phthalocyanine, chlorogallium phthalocyanine, hydroxygallium phthalocyanine, magnesium phthalocyanine, and metal-free phthalocyanine. The phthalocyanines exist in many crystal forms, which have a strong influence on photo-generation.

Any suitable polymeric film forming binder material may be employed as the matrix in the charge generating (photogenerating) binder layer. Typical polymeric film forming materials include those described, for example, in U.S. Pat. No. 3,121,006, the entire disclosure of which is incorporated herein by reference. Thus, typical organic polymeric film forming binders include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrenealkyd resins, polyvinylcarbazole, and the like. These polymers may be block, random or alternating copolymers.

The photogenerating composition or pigment is present in the resinous binder composition in various amounts. Generally, however, from about 5 percent by volume to about 90 percent by volume of the photogenerating pigment is dispersed in about 10 percent by volume to about 95 percent by volume of the resinous binder. In embodiments, preferably from about 20 percent by volume to about 30 percent by volume of the photogenerating pigment is dispersed in about 70 percent by volume to about 80 percent by volume of the resinous binder composition. In one embodiment about 8 percent by volume of the photogenerating pigment is dispersed in about 92 percent by volume of the resinous binder composition. The photogenerator layers can also fabricated by vacuum sublimation in which case there is no binder.

Any suitable and conventional technique may be utilized to mix and thereafter apply the photogenerating layer coating mixture. Typical application techniques include spraying, dip coating, roll coating, wire wound rod coating, vacuum sublimation, and the like. For some applications, the generator layer may be fabricated in a dot or line pattern. Removing the solvent of a solvent coated layer may be effected by any suitable conventional technique such as oven drying, infrared radiation drying, air drying and the like.

In fabricating a photosensitive imaging member, a charge generating material (CGM) or pigment, herein the terms “pigment” and “charge generating material” are used interchangeably, and a charge transport material (CTM) may be deposited onto the substrate surface either in a laminate type configuration where the CGM and CTM are in different layers or in a single layer configuration where the CGM and CTM are in the same layer along with a binder resin. A photoreceptor can be prepared by applying over the electrically conductive layer the charge generation layers and a charge transport layer. In embodiments, the charge generating layer and the charge transport layer may be applied in any order.

In embodiments, the charge generating layer adjacent to the charge transporting layer is partially trapping to charge generated in the other charge generating layer(s) which are passing through this layer to the charge transporting layer. Normally, the above photoexcited charges are holes so the generation layer adjacent to the transport layer must be partially trapping to holes transiting through it, but if the transport layer transports electrons it would be electron trapping. This functionality can be in the pigment itself, that is, the pigment may be a good electron transporter but a poor hole transporter. Such pigments are sometimes referred to as extrinsic pigments because they require the presence of hole transport, i.e., electron donor, molecules. Examples of extrinsic electron transporting pigments are perylene and azo pigments and their derivatives. The degree of hole trapping can be controlled by introducing hole transport molecules either directly or by diffusion from the charge transport layer. Examples of charge transport materials are listed below. Alternatively or in combination, additives can be used to increase the charge trapping. Thus in case of ambipolar, also referred to as intrinsic, pigments such as phthalocyanines, trapping additives in combination with charge transport molecules can be added. Suitable additives are other charge transport materials whose energy levels are 0.2 eV different from the primary charge transport molecule.

Charge transport materials include an organic polymer or non-polymeric material capable of supporting the injection of photoexcited holes or transporting electrons from the photoconductive material and allowing the transport of these holes or electrons through the organic layer to selectively dissipate a surface charge. Illustrative charge transport materials include for example a positive hole transporting material selected from compounds having in the main chain or the side chain a polycyclic aromatic ring such as anthracene, pyrene, phenanthrene, coronene, and the like, or a nitrogen-containing hetero ring such as indole, carbazole, oxazole, isoxazole, thiazole, imidazole, pyrazole, oxadiazole, pyrazoline, thiadiazole, triazole, and hydrazone compounds. Typical hole transport materials include electron donor materials, such as arylamines; carbazole; N-ethyl carbazole; N-isopropyl carbazole; N-phenyl carbazole; tetraphenylpyrene; 1-methyl pyrene; perylene; chrysene; anthracene; tetraphene; 2-phenyl naphthalene; azopyrene; 1-ethyl pyrene; acetyl pyrene; 2,3-benzochrysene; 2,4-benzopyrene; 1,4-bromopyrene; poly (N-vinylcarbazole); poly(vinylpyrene); poly(-vinyltetraphene); poly(vinyltetracene) and poly(vinylperylene).

Aryl amines selected as the hole transporting component include molecules of the following formula 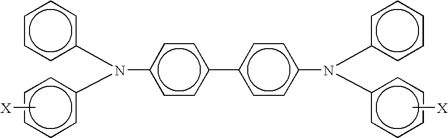
preferably dispersed in a highly insulating and transparent polymer binder, wherein X is an alkyl group, a halogen, or mixtures thereof, especially those substituents selected from the group consisting of Cl and CH₃.

Examples of specific aryl amines are N,N′-diphenyl-N,N′-bis(alkylphenyl)-1,1-biphenyl-4,4′-diamine wherein alkyl is selected from the group consisting of methyl, ethyl, propyl, butyl, hexyl, and the like; and N,N′-diphenyl-N,N′-bis(halophenyl)-1,1′-biphenyl-4,4′-diamine (TPD) wherein the halo substituent is preferably a chloro substituent. Other known charge transport layer molecules can be selected, reference for example U.S. Pat. Nos. 4,921,773 and 4,464,450, the disclosures of which are totally incorporated herein by reference.

Suitable electron transport materials include electron acceptors such as 2,4,7-trinitro-9-fluorenone; 2,4,5,7-tetranitro-fluorenone; dinitroanthracene; dinitroacridene; tetracyanopyrene and dinitroanthraquinone, biphenylquinone derivatives and phenylquinone derivatives.

Any suitable inactive resin binder with the desired mechanical properties may be employed in the charge transport layer. Typical inactive resin binders soluble in methylene chloride include polycarbonate resin, polyvinylcarbazole, polyester, polyarylate, polystyrene, polyacrylate, polyether, polysulfone, and the like. Molecular weights can vary from about 20,000 to about 1,500,000.

Any suitable technique may be utilized to apply the charge transport layer and the charge generating layers. Typical application techniques include spraying, dip coating, roll coating, wire wound rod coating, vacuum coating, and the like. Drying of the deposited coating may be effected by any suitable conventional technique such as oven drying, infra-red radiation drying, air drying and the like. Generally, the thickness of each charge generating layer ranges from about 0.1 micrometer to about 3 micrometers and the thickness of the transport layer is from about 5 micrometers to about 100 micrometers, but thicknesses outside these ranges can also be used. The thickness of the charge generating layer adjacent to the charge transport layer is selected so that the required fraction of the charge is trapped resulting in the desired voltage. The desired thickness is then governed by the fraction of charge transiting the charge generating layer adjacent to the charge transport layer. In general, the ratio of the thickness of the charge transport layer to the charge generating layer is preferably maintained from about 2:1 to 200:1 and in some instances. as great as 400:1.

An imaging device in accordance with the present disclosure also includes an overcoat layer formed from a film forming polymer. An overcoat layer in accordance with the present disclosure is a polymer layer consisting essentially of a film forming polymer material. The overcoat layer is, in embodiments, substantially free of charge transport materials at the time the overcoat layer is formed or coated on the charge transport layer.

The overcoat layer is formed from an overcoat composition. An overcoat composition includes a film forming polymeric binder material and a solvent. In some embodiments, an overcoat composition consists essentially of a film forming polymeric binder material and a solvent. The overcoat composition is substantially free of charge transport materials. The film forming polymeric binder material is selected from the group consisting of polycarbonates, polystyrenes, polyarylates, polyesters, polyimides, polysiloxanes, polysulfones, polyphyenyl sulfides, polyetherimides, polyphenyl vinylenes, combinations thereof, and the like. In one embodiment, the film forming polymeric binder material is a polycarbonate polymer. Examples of suitable polycarbonate polymers include, but are not limited to, LEXAN™ polymers available from the General Electric Company and MAKROLON® polymers available from Bayer. Some examples of suitable LEXAN™ polymers include, but are not limited to, LEXAN™ 3250, LEXAN™ PPC 4501, LEXAN™ ML 5273 and LEXAN™ PPC 4701.

The solvent in the overcoat composition is generally selected based on the polymer material of the charge transport layer. The solvent of the overcoat composition must be capable of dissolving the polymer material of the underlying charge transport layer. Without being bound to any particular theory, if the solvent of the overcoat composition is not capable of dissolving the polymer material of the charge transport layer, the solvent of the overcoat layer will deplete the charge transport material from the base polymer of the charge transport layer and leave a CTM-deficient layer between the overcoat layer and the base layers of the imaging member. This would result in a decrease in electrical performance. Further, the overcoat layer would then contain a relatively large concentration of charge transport material and the deletion performance of the imaging member is compromised.

Suitable solvents for the overcoat composition include, but are not limited to, methylene chloride, monochlorobenzene, tetrahydrofuran (THF), toluene, dioxolane, and the like. It will be readily ascertainable by a skilled artisan what solvents will be suitable for the overcoat composition based on the selected composition of the charge transport layer.

The coating composition exhibits a viscosity based upon the total solids content of the composition. In embodiments, the overcoat composition consists essentially of a film forming polymer and the viscosity is based upon the total solids content of the film forming polymer. The magnitude of diffusion of a charge transport material into the overcoat layer depends on the viscosity of the overcoat composition devices. The magnitude of diffusion of a charge transport material from the underlying charge transport layer into the overcoat layer is inversely related to the viscosity of the overcoat composition. The higher the viscosity of the overcoat composition, the lower the magnitude of diffusion of charge transport materials into the overcoat layer. The viscosity of the overcoat composition, however, is limited. Generally, the overcoat composition should have a solids content such that the composition exhibits a viscosity where the composition is flowable. As used herein, a composition is considered flowable if it is compatible with liquid deposition methods such as, for example, one or more of dip coating, spin coating, or the like. In one embodiment, an overcoat composition may have a solids content that is less than the percent solids at which the overcoat composition exhibits a viscosity of from about 50 cps to about 50,000 cps or more measured at 1.0 s⁻¹ shear rate at 25° C. using a rheometer. In other embodiments, an overcoat composition has a solids content such that the overcoat composition has a viscosity of from about 20,000 cps to about 30,000 cps measured at 1.0⁻¹ shear rate at 25° C. using a rheometer. The solids content at which the overcoat composition exhibits a suitable viscosity depends on the type of polymer employed in the coating composition and the molecular weight of the polymer. Generally, as the molecular weight of the polymer increases, the upper limit of the solids content decreases. Other parameters, such as, for example, the functionality of the polymer, may affect the molecular weight-viscosity relationship. In embodiments, the overcoat layer is formed from a flowable, high viscosity overcoat composition. As used herein, a high viscosity overcoat composition has a solids content that is at least about 50% of the upper solids content limit of the coating composition.

In one embodiment, an overcoat composition may comprise a polycarbonate polymer, such as, for example, LEXAN™ or MAKROLON® and have a viscosity of about 26,000 cps at 1.0 s⁻¹ shear rate at 25° C. In another embodiment, an overcoat composition comprising a polycarbonate polymer has a solids content of less than about 14%.

The thickness of the overcoat layer may be selected as desired for a particular purpose or intended use. The thickness is selected in view of the desired electrical properties and the overcoat composition. If the overcoat layer is too thick, the background potential of the imaging member will increase. Generally, the thickness of the overcoat layer is less than about 10 micrometers. The upper limit of the thickness also depends on the polymer material used to form the overcoat layer and/or the molecular weight of the polymer material.

In one embodiment, an overcoat layer is provided from an overcoat composition that includes methylene chloride as the solvent and a polycarbonate polymer, such as, for example, LEXAN™ or MAKROLON®, as the polymer material. In another embodiment, the polycarbonate polymer is a LEXAN™ or MAKROLON®, having a molecularweight of from about 30,000 to about 500,000, the and the overcoat composition has a solids content of less than 14% and the overcoat layer has a thickness of less than about 6 micrometers.

An overcoat layer can be prepared by any suitable conventional technique such as, for example, by mixing the solvent and the polymer material. The overcoat layer may be applied to the charge transport layer by any suitable application methods. Non-limiting examples of suitable application methods include, for example, hand coating, spray coating, web coating, dip coating, and the like. Drying of the deposited coating can be effected by any suitable conventional technique such as, for example, oven drying, infrared radiation drying, air drying, and the like. The processing speed, drying temperature, and drying time are selected such that the overcoat layer has less than about 1% percent solvent remaining in the layer after drying.

An overcoat layer is, in embodiments, substantially free of any charge transport materials. Some of the charge transport material will likely defuse into the overcoat layer during processing and formation of the overcoat layer. The concentration of charge transport material in the overcoat layer and particularly near the surface of the coating layer can be controlled by the viscosity of the overcoat composition, the drying conditions, and the processing speeds.

Employing an overcoat layer in accordance with the present disclosure in a photoconductive imaging member provides an imaging member that is less susceptible to deletion, lateral charge migration, and/or stress cracking.

Aspects of the present disclosure are further understood with reference to the following examples. The examples are merely for further describing various aspects of an overcoat layer in accordance with the present disclosure and are not intended to be limiting embodiments thereof.

### EXAMPLES

Overcoat Compositions

Overcoat compositions were prepared with a polycarbonate polymer. Four overcoat solutions were prepared by mixing LEXAN™ ML 5273 with a solvent. Two of the overcoat compositions were prepared with methylene chloride as the solvent, and two of the overcoat compositions were prepared with THF as the solvent. Additionally, solutions were prepared using MAKROLON® 5705 and methylene chloride. Overcoat compositions were prepared with solids contents of 7% and 12%.

Imaging Devices

Imaging devices were prepared as follows. A production machine coated PEN/Mylar/TiZr/Silane/Ardel substrate was provided and a HOGaPc/PCZ-200 photogenerating layer was production machine coated over the substrate. A charge transport layer was hand coated on the charge generating layer. The charge transport solution was made by mixing 5 grams of N,N′-diphenyl-N,N′-bis(3-methylphenyl)-1,1′-biphenyl-4,4′-diamine (TPD), a hole transport molecule, and 5 grams of MAKROLON® in 60 grams of methylene chloride in a bottle by stirring until all solids dissolve. The charge transport layer was coated using web coating methods by drawing a 6 inch bird bar with a 4.5 mil gap across the device to deposit a charge transport layer having a thickness of about 25 micrometers. The coating was dried in a forced air oven for about 1 minute at about 120° C.

Devices with overcoat layers were formed using the LEXAN™ ML 5273 and MAKROLON® 5705 overcoat compositions described above. The overcoat layers were formed by hand coating the overcoat compositions using a web coating method as follows. A 1.0 mil blade gap was drawn across a dried charge transport layer to deposit an overcoat layer having a thickness of from about 1 and 5 micrometers. The overcoat layers were then dried in a forced air oven. The drying method varied based on the overcoat formulations. Generally, for the polymer overcoats, a 5 minute ramping scheme was used to bring the temperature from 80° C. to 120° C. The devices differed in the overcoat composition utilized to form the overcoat layer and the thickness of the overcoat layer. Control devices (Controls 1 and 2) were prepared without any overcoat layer. The specifics of the respective layers are shown in Tables 1 and 2.

TABLE 1

| | | | | | Solid content of | | | | |
|---|---|---|---|---|---|---|---|---|---|
| | Charge Transport | CTL | | Overcoat | overcoat solution | Dark Decay | E_{1/2} | E_{7/8} | |
| Device | Layer (CTL) | Thickness | Overcoat | Thickness | (% solids) | (500 ms) (V) | (ergs/cm²) | (ergs/cm²) | Vᵣ(V) |
| Control 1 | 50% TPD/ | 25 um | — | — | — | 21 | 1.59 | 3.82 | 17.8 |
| | 50% Makrolon | | | | | | | | |
| 1 | 50% TPD/ | 25 um | LEXAN/ | 3 um | 7% | 24 | 1.50 | 3.64 | 19.6 |
| | 50% Makrolon | | CH₂CL₂ | | | | | | |
| 2 | 50% TPD/ | 25 um | LEXAN/ | 5 um | 12% | 26 | 1.46 | 3.47 | 16.9 |
| | 50% Makrolon | | CH₂CL₂ | | | | | | |
| 3 | 50% TPD/ | 25 um | LEXAN/THF | 3 um | 7% | 18 | 2.10 | 12.3 | 123.7 |
| | 50% Makrolon | | | | | | | | |
| 4 | 50% TPD/ | 25 um | LEXAN/THF | 5 um | 12% | 19 | 1.99 | N/A | 117.8 |
| | 50% Makrolon | | | | | | | | |
| Control 2 | 50% TPD/ | 30 um | — | — | — | 26 | 1.07 | 2.34 | 24 |
| | 50% Makrolon | | | | | | | | |
| 5 | 50% TPD/ | 30 um | MAKROLON/ | 4 um | 7% | 18 | 1.02 | 2.42 | 33 |
| | 50% Makrolon | | CH₂CL₂ | | | | | | |
| 6 | 50% TPD/ | 30 um | MAKROLON/ | 5 um | 12% | 17 | 1.05 | 2.52 | 34 |
| | 50% Makrolon | | CH₂CL₂ | | | | | | |

TABLE 2
50K Cycling Data Demonstrating that Makrolon/
CH₂CL₂ Overcoat Devices Are Comparable to Control

| | | ΔV₀ | ΔV_{ddp} | ΔVbg | ΔVᵣ |
|---|---|---|---|---|---|
| | | (Last Cycle − | (Last Cycle − | (Last Cycle − | (Last Cycle − |
| Device # | Overcoat | Cyc 100) | Cyc 100) | Cyc 100) | Cyc100) |
| Control 2 | No - Overcoat | 15.65 | 20.85 | 50.70 | 9.65 |
| 5 | 7% MAKROLON | 12.15 | 16.10 | 33.15 | 4.45 |
| 6 | 12% MAKROLON | 6.80 | 9.45 | 22.85 | −2.35 |

Testing

Electrical Evaluation

The xerographic electrical properties of each imaging member were determined by electrostatically charging its surface with a positive corona discharging device until the surface potential, as measured by a capacitively coupled probe attached to an electrometer, attained an initial value Vₒ of about −800 volts After resting for 0.5 second in the dark, the charged member reached a surface potential of V_{ddp}, dark development potential, and was then exposed to light from a filtered xenon lamp. A reduction in the surface potential to V_{bg}, background potential due to photodischarge effect, was observed. Usually the dark decay in volt/second was calculated as (Vₒ−V_{ddp})/0.5. The lower the dark decay value, the more favorable is the ability of the member to retain its charge prior to exposure by light. Similarly, the lower the V_{ddp}, the poorer is the charging behavior of the member. Photodischarge characteristics are represented by E_{1/2} and E_{7/8} values. E_{1/2} is the exposure energy required to achieve a photodischarge from Vddp to ½ of Vddp and E_{7/8} the energy for a discharge from Vddp to ⅛ of Vddp. The light energy used to photodischarge the imaging member during the exposure step was measured with a light meter. The higher the photosensitivity, the smaller are E_{1/12} and E_{7/8} values. Residual potential after erase Vr was measured after the device was further subjected to a high intensity light irradiation. Higher photosensitivity (low E_{1/2}, E_{7/8} value), low dark decay and high charging are desired for the improved performance of xerographic imaging members.

The cyclic stability of the devices was assessed by performing repetitive charging and discharging over 50,000 cycles. The changes in Vo, Vddp, Vbg and Vr were monitored by subtracting the initial voltages at 100 cycle from the final voltages of last cycle. The smaller the changes the better is the cyclic stability, another important attribute for a functional devices.

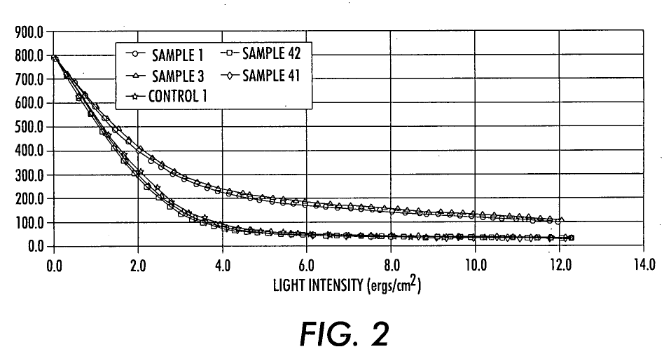

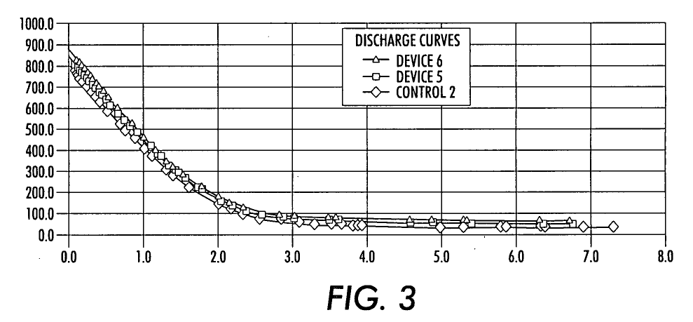

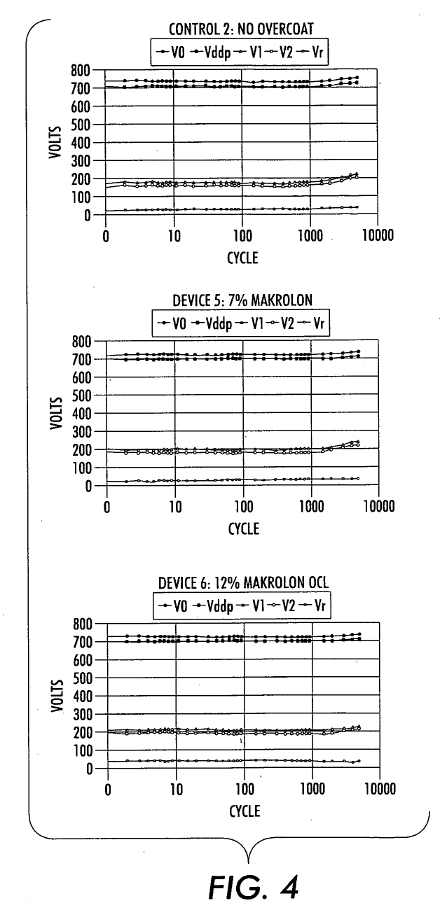

As shown in Tables 1 and 2 and FIGS. 2-4, the devices employing the LEXAN™ or MAKROLON®/methylene chloride overcoat composition exhibited electrical properties comparable to the Controls. The devices with the MAKROLON® overcoat layers also exhibited good electrical properties. The LEXAN™/THF exhibited poor electrical properties indicating that THF was not a suitable solvent for dissolving the MAKROLON® polymer of the CTL.

Deletion Resistance

Deletion resistance was evaluated by a lateral charge migration (LCM) print testing scheme. The various hand coated devices were cut into 6″×1″ strips. One end of the strip from the respective devices was cleaned using a solvent to expose the metallic conductive layer on the substrate. The conductivity of the layer was then measured to ensure that the metal had not been removed during cleaning. The conductivity of the layer was measured using a multimeter to measure the resistance across the exposed metal layer (around 1 KOhm). A fully operational 85 mm DC12 photoreceptor drum was prepared to expose a lengthwise strip of bare aluminum (0.5″×12″) to provide the ground for the handcoated device when it is operated. The cleaning blade was removed from the drum housing to prevent it from removing the handcoated devices during operation.

The hand coated devices were then mounted onto a photoreceptor drum using conductive copper tape to adhere the exposed conductive end of the devices to the exposed aluminum strip on the drum to complete a conductive path to the ground. After mounting the devices, the device-to-drum conductivity was measured using a standard multimeter in resistance mode. The resistance between the respective devices and the drum should be similar to the resistance of the conductive coating on the respective hand coated devices. The ends of the devices are then secured to the drum using scotch tape, and all exposed conductive surfaces must be covered with scotch tape. Up to seven devices may be mounted, side by side, on one drum. The drum was then placed in a DC12 machine and a template containing 1 bit, 2 bit, 3 bit, 4 bit, and 5 bit lines was printed. The machine settings (e.g., dev bias, laser power, grid bias, etc.) were adjusted to get a proper print on the hand coated devices. If the 1 bit line is barely showing, then the settings are saved and the print becomes the reference, i.e., the pre-exposure print. The drum was removed and placed in a fume hood where a corotron housing was mounted onto the drum. The housing makes a near tight seal over the devices with the wire only a few millimeters from the devices. A current of 500 μA was run through the wire at 1 Hz alternating frequency for 20 minutes. The housing was then removed and the drum was placed back into the printer and another print was made to determine if any lateral charge migration occurred. Several prints were made over lengthening time intervals to show the recovery of the exposed area of the devices.

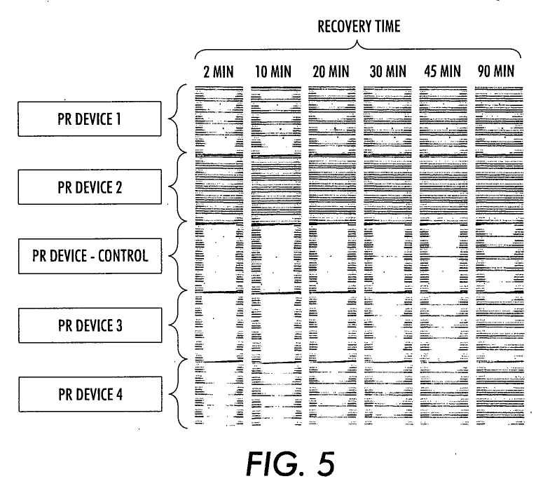

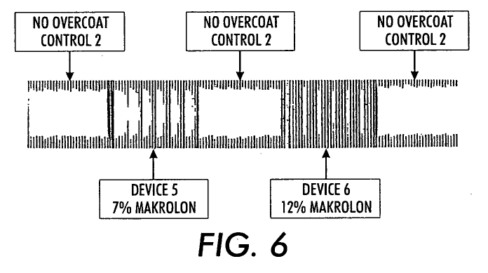

FIGS. 5 and 6 are pictures comparing the deletion resistance of the above devices. As shown in FIGS. 5 and 6 an imaging device with polymer overcoat layers in accordance with the disclosure exhibit excellent deletion resistance. Additionally, greater deletion resistance can be achieved with higher viscosity coating compositions (e.g., the 12% LEXAN™ or MAKROLON® compositions). The overcoat formed from the LEXAN™/methylene chloride overcoat composition exhibits the greatest deletion resistance compared to the other test devices.

Stress Cracking

Stress cracking was evaluated as follows. Hand coated devices were cut into 10″×2″ strips. The devices were then mounted onto a tri-roller stress tester and rotated at about 60 rpm for 500,000 cycles, which mimics mechanical stress that photoreceptor belts undergo during operation inside conventional printers. The devices were removed from the tri-roller and one end of the strip was cleaned using solvent to expose the metallic conductive layer on the substrate. The conductivity of that layer was then measured to ensure that the metal had not been removed during cleaning. The resistance across the exposed metal layer was measured using a multimeter (about 1 KOhm).

A fully operational 85 mm DC12 photoreceptor drum was specially prepared to expose a lengthwise 0.5″×12″ strip of bare aluminum. This provides the ground for the hand coated devices when in operation. The cleaning blade was also removed from the drum housing to prevent is from removing the hand coated devices during operation. The hand coated devices were mounted on the 85 mm DC12 drum using conductive copper tape to adhere the exposed conductive end of the respective devices to the exposed aluminum strip on the drum to complete the conductive path to the ground. Once mounted, the device-to-drum conductivity was measured using a standard multimeter in resistance mode. The resistance between the devices and the drum should be similar to the resistance of the conductive coating on the hand coated device. Once the conductivity was determined to be high enough, the ends of the respective devices were secured using scotch tape such that all exposed ends wee covered with scotch tape. The drum was then placed in the DC12 machine and a blank print was made (white background). The machine settings were adjusted to get clean print showing dark marks where small cracks have formed in the CTL layer of the device. The undamaged marks of the device should print white.

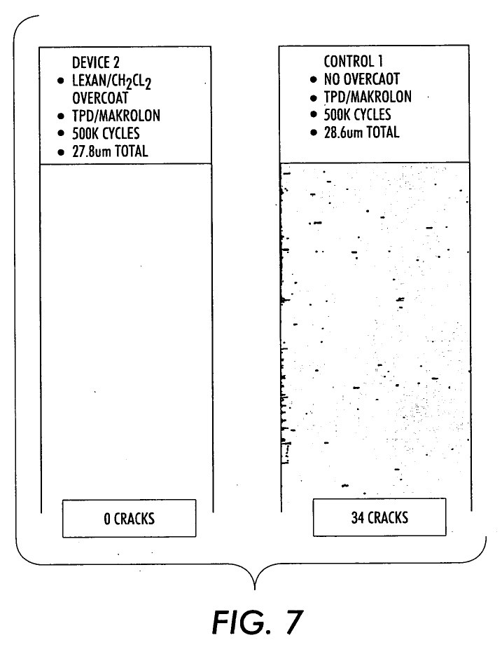

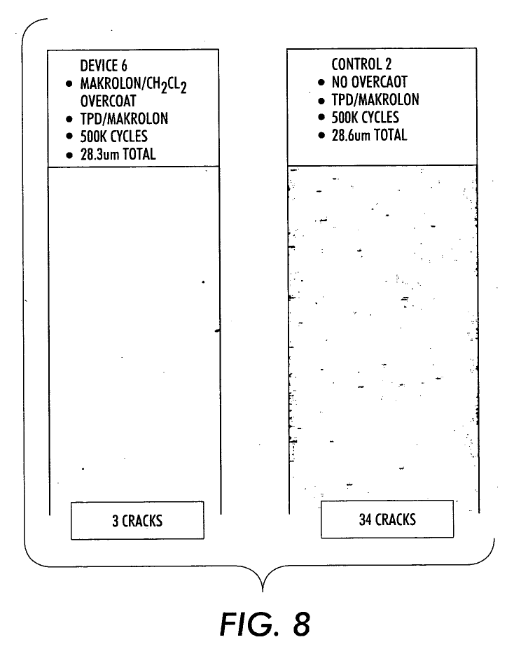

FIGS. 7 and 8 are printouts comparing the stress cracking of a device comprising a high-viscosity polymer overcoat layer and a control device. As shown in FIGS. 7 and 8, the devices with the polymer overcoat in accordance with the disclosure had 0 or fewer cracks after 500,000 cycles, while the control devices had 34 cracks.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for forming an imaging member comprising: (a) providing a layer comprising a charge transport material; and, (b) depositing a flowable, high viscosity overcoat composition over the layer comprising the charge transport material.

2. The method of claim 1, wherein the overcoat composition has a viscosity of from about 50 cps to about 50,000 cps or more measured at a shear rate of 1.0 s⁻¹ at 25° C.

3. The method of claim 1, wherein the overcoat composition has a solids content such that the overcoat composition exhibits a viscosity between about 20,000 cps and 30,000 cps measured at a shear rate of 1.0 s⁻¹ at 25° C.

4. The method according to claim 1, wherein the overcoat composition comprises a film forming polymer material selected from the group consisting of polycarbonates, polystyrenes, polyarylates, polyesters, polyimides, polysiloxanes, polysulfones, polyphenyl sulfides, polyetherimides, polyphenylene vinylenes, and combinations thereof.

5. The method according to claim 1, wherein the overcoat composition has a solids content such that the overcoat composition exhibits a viscosity of about 26,000 cps at a shear rate of 1.0 s⁻ at 25° C.

6. The method according to claim 1, wherein the overcoat composition has a solids content greater than 0% by weight and less than the percent solids at which the overcoat composition exhibits a viscosity of 50,000 cps or more measured at a shear rate of 1.0s⁻¹ at 25° C.

7. The method according to claim 4, wherein the film forming polymer material is a polycarbonate.

8. The method according to claim 7, wherein the overcoat composition has a solids content of less than 14% by weight.

9. The method of claim 1, wherein the overcoat composition comprises a solvent.

10. The method of claim 1, wherein at least the outer surface of the layer formed by the overcoat composition is substantially free of charge transport material.

11. An imaging member having an overcoat layer formed by the process of claim 1.

12. An imaging member having an overcoat layer formed by the process of claim 10.

13. An imaging member comprising an overcoat layer disposed over an imaging member layer comprising a charge transport material, wherein the overcoat layer is formed from a flowable, high viscosity overcoat composition comprising a film forming polymer material and a solvent, and wherein the viscosity of the overcoat composition is sufficient to minimize the diffusion of the charge transport material from the imaging member layer into the overcoat layer.

14. The imaging member according to claim 13, wherein at least the outer surface of the overcoat layer is substantially free of charge transport material.

15. The imaging member according to claim 13, wherein the film forming polymer material is selected from the group consisting of polycarbonates, polystyrenes, polyarylates, polyesters, polyimides, polysiloxanes, polysulfones, polyphenyl sulfides, polyetherimide, polyphenyl vinylene, and combinations thereof.

16. The imaging member accordingly to claim 13, wherein the overcoat layer has a thickness of less than about 10 micrometers.

17. The imaging member according to claim 13, wherein the film forming polymer is a polycarbonate.

18. The imaging member according to claim 13, wherein the high viscosity overcoat composition has a viscosity of from about 50 cps to about 50,000 cps measured at a shear rate of 1.0 s⁻¹ at 25° C. using a rheometer.

19. The imaging member according to claim 13, wherein the overcoat composition has a solids content of less than the percent solids at which the overcoat composition exhibits a viscosity of 50,000 cps or more measured at a shear rate of 1.0ₛ⁻¹ at 25° C. using a rheometer.

20. A method of imaging which comprises generating an electrostatic latent image on the imaging member of claim 13, developing the latent image and transferring the developed electrostatic image to a suitable substrate.
